(19) United States
(12) Patent Application Publication
(10) Pub. No.: US 2025/0226450 A1
(43) Pub. Date: Jul. 10, 2025

(54) Liquid Electrolyte Composition Comprising a Salt, Electrochemical Cell Comprising the Electrolyte Composition, Salt, and Use of the Salt in the Electrochemical Cell

(71) Applicant: Bayerische Motoren Werke Aktiengesellschaft, Muenchen (DE)

(72) Inventors: Alexander ADAM, Muenchen (DE); Juliane KLUGE, Muenchen (DE); Arianna MORETTI, Muenchen (DE); Sebastian SCHARNER, Tuerkenfeld (DE)

(21) Appl. No.: 19/101,014

(22) PCT Filed: Jul. 6, 2023
(86) PCT No.: PCT/EP2023/068685

§ 371 Date: Feb. 4, 2025

(30) Foreign Application Priority Data
Jul. 13, 2022 (WO) PCT/EP2022/069660
Nov. 17, 2022 (DE) 10 2022 130 388.8

(51) Int. Cl. H01M 10/0568; H01M 10/0525; H01M 10/0567; H01M 10/0569

(52) U.S. Cl. CPC H01M 10/0568; H01M 10/0525; H01M 10/0567; H01M 10/0569; H01M 2300/0037

(57) ABSTRACT

Liquid electrolyte compositions comprising a salt of the formula (I) which has an anionic complex comprising three bidentate ligands are provided. The complex comprises antimony as the central ion. Electrochemical cells comprising the liquid electrolyte composition are further provided. Salts of formula (I) are further provided.

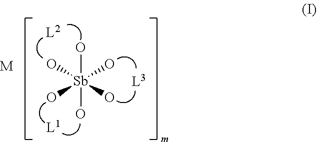

### BACKGROUND AND SUMMARY

The present disclosure relates to an electrolyte composition comprising a salt, to an electrochemical cell comprising the electrolyte composition, to a salt and to a use of the salt in the electrochemical cell.

Electrochemical cells are of great importance in many technical fields. In particular, electrochemical cells are often employed for applications where low voltages are required such as for example for the operation of laptops or mobile telephones. An advantage of electrochemical cells is that many individual cells may be connected to one another. For example cells can provide a high voltage through serial interconnection while parallel interconnection of the cells affords a high nominal capacity. Such interconnections result in batteries having a high energy. Such battery systems are also suitable for high-voltage applications and can allow for example electrical propulsion of vehicles or be utilized for stationary energy storage.

In the following the term “electrochemical cell” is used synonymously for all descriptions used in the art for rechargeable galvanic elements, for example cell, battery, battery cell, accumulator, battery accumulator and secondary battery.

An electrochemical cell is capable of providing electrons for an external circuit during a discharging operation. Conversely an electrochemical cell may be charged by supply of electrons using an external circuit during a charging operation.

An electrochemical cell has at least two different electrodes, a positive electrode (cathode) and a negative electrode (anode). Both electrodes are in contact with an electrolyte composition.

The most commonly used electrochemical cell is the lithium-ion cell, also known as a lithium-ion battery.

Lithium-ion cells known from the art comprise a composite anode which very often comprises a carbon-based anode active material, typically graphitic carbon, which is deposited on a metallic copper carrier foil. The cathode generally comprises metallic aluminum coated with a cathode active material, for example a layered oxide. Employable layered oxides include for example LiCoO₂ or LiNi_{1/3}Mn_{1/3}Co_{1/3}O₂ which is coated on a rolled aluminum carrier foil.

The electrolyte composition plays an essential role for the safety and performance of an electrochemical cell. The electrolyte composition ensures charge equalization between the cathode and the anode during charging and discharging operations. The current flow necessary therefor is achieved by ion transport of a conducting salt in the electrolyte composition. In the case of lithium-ion cells the conducting salt is a lithium conducting salt and lithium ions serve as the current-transporting ions.

It is therefore necessary to select a suitable conducting salt which can not only be dissolved in the electrolyte composition to a sufficient extent but also exhibits suitable ion conductivity to maintain effective charge equalization during operation. The most commonly used conducting salt in lithium-ion cells is lithium hexafluorophosphate (LiPF₆).

In addition to the lithium, conducting salt electrolyte compositions contain a solvent, which ensures dissociation of the conducting salt and sufficient mobility of the lithium ions. The art discloses liquid organic solvents composed of a selection of linear and cyclic dialkyl carbonates. Mixtures of ethylene carbonate (EC), dimethyl carbonate (DMC), diethyl carbonate (DEC), propylene carbonate (PC) and ethyl methyl carbonate (EMC) are generally employed.

It must be noted that every solvent exhibits a specific stability range for the cell voltage, also known as the “voltage window”. The electrochemical cell can operate in a stable manner during operation in this voltage window. If the cell voltage approaches the upper voltage limit an electrochemical oxidation of the constituents of the electrolyte composition occurs. By contrast, reductive processes occur at the lower end of the voltage window. Both redox reactions are unwanted, reduce the performance and reliability of the cell and in the worst case lead to failure thereof.

The processes concerned here are especially relevant for deep discharging and overcharging of a lithium-ion cell.

Lithium-ion cells comprising organic electrolyte compositions from the art have a tendency for gasification during charging and discharging operations. The term “gasification” is to be understood as meaning an electrochemical decomposition of the constituents of the electrolyte into volatile and gaseous compounds due to the use of an excessively high cell voltage. Gasification reduces the proportion of electrolyte and leads to formation of undesired decomposition products, thus resulting in a lower service life and a lower performance of the lithium-ion cell.

In order that the cell can operate in the widest possible potential range the art discloses adding fluorinated solvents or additives to the electrolyte compositions. Fluorinated solvents such as fluoroethylene carbonate (FEC) are chemically inert and electrochemically stable toward the operating voltages of the lithium-ion cell.

A widespread disadvantage of fluorinated electrolytes is that a thermal defect in the cell can lead to elevated evolution of heat and to formation and emission of health-hazardous gases such as hydrogen fluoride (HF).

On account of these disadvantages lithium-ion cells have a multitude of control mechanisms to maintain the cells in a voltage range optimal for the respective solvent during operation and thus stabilize the electrolyte composition.

The art discloses various approaches for stable electrolyte compositions.

EP 1 689 756 B1 describes a process for producing weakly coordinating anions of formula X(OR^{F})ₘ, wherein X is selected from the group consisting of B, Al, Ga, In, P, As and Sb, m is 3 or 5 and R^{F} represents a straight-chain or branched-chain, partially or completely fluorinated alkyl or aryl radical. The weakly coordinating anions form salts with monovalent or divalent cations, preferably with alkali metal ions. Due to their chemical stability, especially of the anion, the disclosed salts were proposed inter alia for use as inert lithium conducting salts in lithium-ion batteries. However, an electrolyte composition comprising the weakly coordinating anions for use in lithium-ion batteries was not demonstrated.

In addition to the selection of a chemically inert conducting salt, the selection of a suitable solvent can also increase the stability of the battery cells. Sulfur dioxide (SO₂) is now being discussed as an inorganic solvent in electrolyte compositions. Sulfur dioxide-based electrolyte compositions especially exhibit an elevated ion conductivity and thus allow operation of battery cells at high discharging currents without adversely affecting the stability of the cells. Electrolyte compositions based on sulfur dioxide further feature a high energy density, a low self-discharging rate and limited overcharging and deep discharging.

A disadvantage of sulfur dioxide is that sulfur dioxide exhibits only inadequate solubility for many lithium conducting salts which are readily soluble in organic solvents. Thus, for example the often-employed lithium conducting salt lithium hexafluorophosphate cannot be used for sulfur dioxide-containing electrolyte compositions.

EP 1 201 004 B1 discloses a rechargeable electrochemical cell comprising a sulfur dioxide-based electrolyte. Sulfur dioxide is not added as an additive but rather represents the main constituent of the electrolyte composition. It is thus said to at least partially ensure the mobility of the ions of the conducting salt which bring about the charge transport between the electrodes. In the proposed cells lithium tetrachloroaluminate is used as lithium-containing conducting salt in conjunction with a cathode-active material composed of a metal oxide, in particular an intercalation compound such as for example lithium cobalt oxide (LiCoO₂). Addition of a salt additive, for example an alkali metal halide such as lithium fluoride, sodium chloride or lithium chloride, to the sulfur dioxide-containing electrolyte composition resulted in functioning and rechargeable cells.

EP 2534719 B1 discloses a rechargeable lithium battery cell comprising a sulfur dioxide-based electrolyte in conjunction with lithium iron phosphate as the cathode active material. Lithium tetrachloroaluminate was used in the electrolyte composition as the preferred conducting salt. Experiments with cells based on these components demonstrated a high electrochemical resistance of the cells.

WO 2021/019042 A1 describes rechargeable battery cells comprising an active metal, a layered oxide as the cathode active material and a sulfur dioxide-containing electrolyte. Due to the poor solubility of many commonly used lithium conducting salts in sulfur dioxide the cells employed a conducting salt of formula M⁺[Z(OR)₄]⁻, wherein M is a metal selected from the group consisting of alkali metal, alkaline earth metal and a metal from the group 12 of the Periodic Table of the Elements and R is a hydrocarbon radical. The alkoxy groups —OR are in each case monovalently bonded to the central atom Z which may be aluminum or boron. In a preferred embodiment the cells contain a perfluorinated conducting salt of formula Li⁺[Al(OC(CF₃)₃)₄]⁻. Cells composed of the described components show stable electrochemical performance in experimental studies. In addition, the conducting salts, in particular the perfluorinated anion, exhibit a surprising hydrolysis stability. The electrolytes are further said to be oxidation-stable up to an upper potential of 5.0 V. It was further demonstrated that cells comprising the disclosed electrolytes can be discharged and charged at low temperatures of down to −41° C. However, no measurements of electrochemical performance at high temperatures were undertaken.

The thermal stability of perfluorinated lithium aluminates at high temperatures was investigated in a paper by Malinowski et al. (Dalton Trans., 2020, 49, 7766). In this study the authors characterized different properties of [Al(OC(CF₃)₃)₄] salts, inter alia the thermal stability of the lithium derivative. Thermogravimetric studies showed that the compound Li[Al(OC(CF₃)₃)₄] already exhibits a mass loss caused by an incipient decomposition of the fluorinated anion at 105° C.

Hitherto discussion has been limited to conducting salts for sulfur dioxide-based electrolytes whose anions form a chemical complex. For the formation of these complexes monodentate, bidentate or polydentate ligands may be used. Bidentate or polydentate ligands are generally also known as chelate ligands and the complexes composed thereof as chelate complexes.

For example EP 4 037 056 A1 describes an SO₂-based electrolyte for a rechargeable battery cell. The electrolyte contains at least one conducting salt which may comprise at least one substituent in the form of a chelate ligand. The chelate ligands coordinate to a central ion which is either boron or aluminum.

Further electrolyte salts comprising chelate ligands in electrolyte compositions for electrochemical cells are disclosed in the applications DE102021118811.3 and PCT/EP2022/069660.

Chelate complexes are chemically stable with respect to their monovalent derivatives. The bonds between the chelate ligands and the central ion can be broken only with difficulty, as a result of which, chelate complexes are chemically inert towards external chemical and physical influences. On account of these properties chelate complexes, in particular the salts composed thereof, are considered both temperature- and hydrolysis-resistant. Electrolyte salts composed of certain chelate complexes therefore have a higher oxidation stability and are therefore capable of reliable operation at higher cell voltages.

For the use of such electrolyte salts in commercially available batteries, in particular in batteries as a propulsion source for electric vehicles, it is necessary for the electrolyte salts to fulfil not only the previously discussed safety-relevant requirements but also certain process engineering and performance-relevant criteria.

One requirement is that electrolyte salts are composed of easily obtainable and cost-effective ligands. Otherwise the batteries produced therefrom are too costly to produce and cannot find economically viable application. Furthermore, electrolyte salts must exhibit a good solubility in sulfur dioxide as solvent since salts having a higher solubility are easier to process. Another criterion is based on a sufficient conductivity of the electrolyte salts in sulfur dioxide in order also to be able to ensure a sufficient electrical efficiency in a battery manufactured therefrom.

There is therefore a need to develop novel electrolyte salts which meet the aforementioned requirements.

The present disclosure accordingly has for its object to provide an electrolyte composition for an electrochemical cell and in particular rechargeable batteries which meets the aforementioned requirements and can be reliably operated at various operating voltages.

The object is achieved according to the present disclosure by a liquid electrolyte composition for an electrochemical cell.

Advantageous embodiments of the electrolyte composition according to the present disclosure are further specified and may be combined with one another as desired.

The object is achieved according to the present disclosure by a liquid electrolyte composition for an electrochemical cell. The electrolyte composition comprises the following components:
(A) sulfur dioxide;
(B) at least one salt, wherein the salt contains an anionic complex comprising three bidentate ligands and corresponds to the salt of following formula (I)

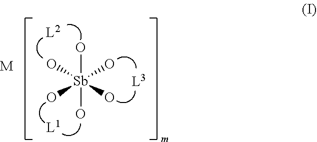

### DETAILED DESCRIPTION

Therein, M represents a metal cation selected from the group consisting of alkali metals, alkaline earth metals and metals of group 12 of the Periodic Table of the Elements. m represents an integer from 1 to 2. Sb represents the element antimony and represents the central ion of the anionic complex. L¹, L² and L³ each independently of one another represent a perfluorinated aliphatic or aromatic bridging radical. The bridging radical forms a five- to eight-membered ring with the central ion Sb and with two oxygen atoms bonded to the Sb and the bridging radical, wherein the ring contains a sequence of 2 to 5 carbon atoms optionally interrupted by an oxygen atom.

The salt proposed according to the present disclosure comprises an anion containing three bidentate ligands. In the context of the present disclosure a bidentate ligand is to be understood as meaning a molecule which comprises at least two oxygen atoms and bonds to the central ion Sb via the at least two oxygen atoms. Polydentate ligands having a different denticity such as for example tridentate, tetradentate, pentadentate, or hexadentate are not in the scope of the present disclosure.

Bidentate ligands are generally also known as chelate ligands and the complexes composed thereof as chelate complexes. The anion of the salt of formula (I) is thus a chelate complex. In the context of the present disclosure, chelate complexes and the salts formed therefrom exhibit a wide variety of advantages compared to the complexes formed from monovalent ligands and the salts formed therefrom.

Chelate complexes are chemically more stable compared to their monovalent derivatives. The bonds between the chelate ligands and the central ion are difficult to break, which is why the chelate complexes according to the present disclosure are chemically inert towards external chemical and physical influences.

According to the present disclosure a chelate complex represents the anion of the at least one salt of formula (I), wherein the salt serves as the conducting salt of the electrolyte composition. The electrolyte composition thus allows charge equalization between the two electrodes with which the composition is in contact.

A further advantage is the high affinity of the chelate ligand to the central ion Sb. The chelate complexes employed according to the present disclosure are chemically and electrochemically stable compounds, which due to the strongly coordinating properties of the ligand to the central ion, exhibit a low affinity for bonding to positively charged ions. The chelate complexes themselves are therefore weakly coordinating anions. The conducting salt in the electrolyte composition can therefore dissociate practically completely without reformation of the starting salt and forms ions having a high mobility and a correspondingly high ionic conductivity in solution. This in turn enhances the electrochemical performance of the electrochemical cell.

On account of these properties the chelate complexes used according to the present disclosure, in particular the salts composed thereof, are both temperature- and hydrolysis-resistant.

According to the present disclosure the described salts are sufficiently soluble in liquid sulfur dioxide which represents the solvent of the electrolyte composition. In the context of the present disclosure sulfur dioxide is present in the electrolyte composition not only as an additive in small concentrations but rather is present to an extent such that sulfur dioxide can ensure the mobility of the ions of the conducting salt as a solvent.

Sulfur dioxide is gaseous at room temperature under atmospheric pressure and with lithium conducting salts forms stable liquid solvate complexes which exhibit a markedly reduced vapor pressure compared to pure sulfur dioxide. The gaseous sulfur dioxide is thus bound in liquid form and may be handled safely and relatively easily. A particular advantage is the non-flammability of sulfur dioxide itself and of the solvate complexes of sulfur dioxide, thus enhancing the operating safety of the electrolyte compositions based on such solvate complexes and the cells produced using the electrolyte composition.

The described salt comprising the chelate complex of formula (I) is non-flammable. As a result the electrolyte compositions according to the present disclosure are also nonflammable and allow safe operation of an electrochemical cell comprising the disclosed components of the electrolyte composition. If sulfur dioxide were to issue from the cell in the event of mechanical damage the sulfur dioxide is not capable of ignition outside the cell.

Furthermore, the electrolyte composition according to the present disclosure is also cost-effective relative to conventional organic electrolytes. The elevated thermal stability and hydrolysis-resistance allow direct and virtually complete recycling of the electrolyte composition from end-of-life batteries without increased cost and complexity. Recycling of end-of-life batteries usually employs hydrothermal processes under high pressure and at high temperatures. Conventional electrolyte compositions are usually not hydrolysis-resistant and must therefore be subjected to a different kind of workup. To this end the electrolyte compositions are laboriously extracted from batteries, for example by purging the cells with supercritical carbon dioxide. By contrast, newer electrolyte formulations based on aluminate, borate, or gallate salts such as are described in the art usually exhibit insufficient thermal stability.

The electrolyte composition proposed here is thermally stable and hydrolysis-resistant and is therefore amenable to cost-effective direct recycling from the electrochemical cells with water-based extraction methods. Due to the water-solubility of the proposed components the presently proposed electrolyte composition has a high recycling potential with a high recycling rate.

Recycling reduces both the primary raw material consumption and the energy demand of the electrolyte composition required for production of a freshly produced electrolyte composition and thus also the carbon dioxide emission brought about during this production process. This makes it possible to minimize the production costs of the electrolyte composition according to the present disclosure and the electrochemical cell produced using the electrolyte composition.

According to the present disclosure the electrolyte composition comprises at least one salt of formula (I), wherein the salt contains an anionic complex comprising three bidentate ligands.

In formula (I) the charge of the anion is stoichiometrically equalized by a positively charged metal cation M selected from the group consisting of alkali metals, alkaline earth metals and metals of group 12 of the Periodic Table of the Elements. The metal cation is preferably a lithium ion and the salt a lithium salt. Accordingly, m is an integer of 1 to 2, wherein m is stoichiometrically specified by the oxidation number of the employed metal cation.

In formula (I) the central ion is formed by antimony. The salts of formula (I) formed therefrom are accordingly antimonates and have a single negative charge. Borates and aluminates and other central ions other than antimony are not within the scope of the present disclosure.

The exclusion of central ions other than antimony is based on the finding that electrolyte salts of boron or aluminum with commercially readily available bidentate ligands, for example perfluoropinacol (PFP), exhibit only a low conductivity in sulfur dioxide as solvent. In other words, the conductivity does not correlate with the solubility of such electrolyte salts in sulfur dioxide.

Without wishing to be bound to a scientific theory it is thought that due to the high surface charge of anionic chelate complexes comprising boron or aluminum as the central ion the sulfur dioxide is not capable of dissociating such complexes into solvated ions. In contrast to aluminates or borates the use of antimony as the central ion can increase the number of bidentate chelate ligands from 2 to 3, thus increasing the radius of the antimonate and reducing the surface charge. A reduced surface charge results in a lower charge density at the anion and the dissociation of the conducting salt in the solvent sulfur dioxide is increased compared to the art. The higher degree of dissociation is associated with a higher electrical efficiency in a battery produced from the electrolyte composition according to the present disclosure.

The bidentate chelate ligand comprises at least two oxygen atoms and a bridging radical L¹, L² or L³ which is bonded to both oxygen atoms.

L¹, L² and L³ each independently of one another represent a perfluorinated aliphatic or aromatic bridging radical. The bridging radicals accordingly contain no hydrogen atoms. The complete fluorination of the bridging radicals ensures that the ligands are altogether stable towards electrolysis and higher cell voltages.

The bridging radical forms a five- to eight-membered ring with the central ion Sb and with two oxygen atoms bonded to the central ion Sb and the bridging radical.

The ring contains a sequence of 2 to 5 carbon atoms optionally interrupted by an oxygen atom. In other words, the ring may especially comprise at least one ether group.

The introduction of such an ether group advantageously makes it possible to reduce the fluorine content of the ring. This also reduces the fluorine content of the ligand as a whole. While fluorinated compounds exhibit a good electrochemical resistance the synthesis of such compounds is complex and cost intensive. Herein, it has been demonstrated that the fluorine content in the ring and thus also of the ligands can be reduced without impairing the electrochemical stability of the ligand when the ring contains heteroatoms. Especially suitable therefor are ether groups which are likewise stable towards oxidative potentials, thus ensuring electrochemical stability of the ligand despite the reduced fluorine content.

In a development of the present disclosure the bridging radicals L¹, L² and/or L³ each comprise a linear, branched or cyclic saturated hydrocarbon skeleton. The term “hydrocarbon skeleton” is here and hereinbelow to be understood as meaning “perfluorinated hydrocarbon skeleton”.

The hydrocarbon radical of the bridging radicals L¹, L² and/or L³ preferably comprises 3 to 16 carbon atoms, preferably 6 to 9 carbon atoms. Hydrocarbon skeletons having a number of hydrocarbon atoms in the recited range produce anions forming particularly stable salts of formula (I).

The bonding of the bridging radicals via the oxygen atoms to the central ion Sb may be considered as a coordinative bond in the context of the present disclosure. The bonding of the ligands to the central ion Sb results in formation of a ring composed of a bridging radical, the two oxygen atoms bonded to the bridging radical and the central ion Sb.

In one aspect of the present disclosure the ring comprises at least one uninterrupted sequence of 2 to 5 carbon atoms, preferably 2, 3 or 5 carbon atoms. In this embodiment no heteroatom is provided in the ring.

Such rings form salts of formula (II)

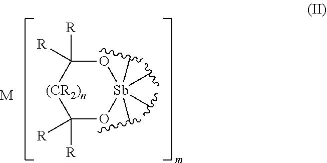

wherein n=0, 1 2 or 3 and R represents a radical. M is a metal cation selected from the group consisting of alkali metals, alkaline earth metals and metals of group 12 of the Periodic Table of the Elements. m is 1 or 2 and Sb represents a central ion which is antimony. The anion of the salt of formula (II) comprises altogether three polycyclic rings according to the bonding scheme of formula (I). The radicals R may be identical or different and independently of one another selected from the group consisting of C₁-C₁₀-alkyl and fluorine.

In the context of the present disclosure the term C₁-C₁₀-perfluoroalkyl comprises linear, branched or branched saturated perfluorinated hydrocarbon radicals having 1 to 10 carbon atoms.

Examples of suitable perfluoroalkyl radicals include trifluoromethyl, perfluoroethyl, perfluoropropyl, perfluoroisoproyl, perfluoro-n-butyl, perfluoro-sec-butyl, perfluoroisobutyl and perfluoro-tert-butyl.

If n in formula (II) is 0 the ring formed by the central ion Sb, the bridging radical and the two oxygen atoms bonded to the bridging radical is pentacyclic and comprises an uninterrupted sequence of 2 carbon atoms.

If n in formula (II) is 1 the ring formed by the central ion Sb, the bridging radical and the two oxygen atoms bonded to the bridging radical is hexacyclic and comprises an uninterrupted sequence of 3 carbon atoms.

If n in formula (II) is 3 the ring formed by the central ion Sb, the bridging radical and the two oxygen atoms bonded to the bridging radical is eight-membered and comprises an uninterrupted sequence of 5 carbon atoms.

In a preferred embodiment n in formula (II) is 0 and the radicals R are identical and represent optionally fluorine-substituted methyl radicals. Such chelate ligands are derived from pinacol as the simplest representative.

In an advantageous development of the present disclosure component (B) of the electrolyte composition comprises at least one lithium salt of formula (I). Lithium salts are especially suitable for use as lithium conducting salts in lithium-ion batteries.

The lithium salt may preferably be selected from the group consisting of Sb(O₂C₃(CF₃)₆)₃ of formula (III)

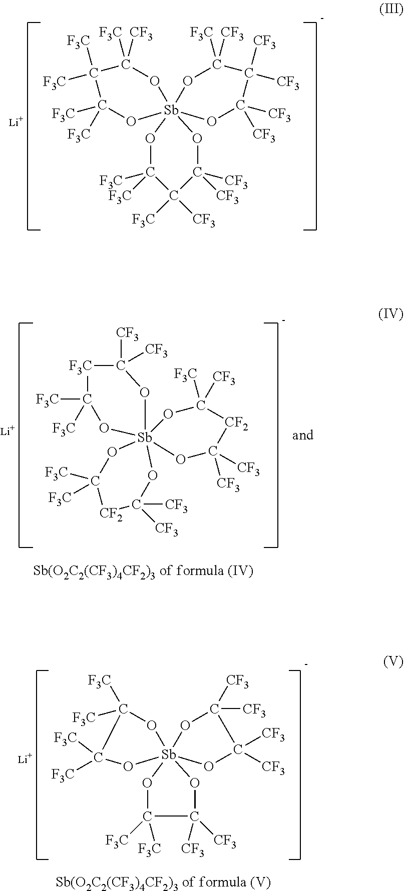

and combinations thereof.

The proposed lithium salts are readily soluble in liquid sulfur dioxide as solvent. The resulting electrolyte compositions are nonflammable and have a very good ion conductivity over a wide temperature range.

The conductivity of the lithium salts is determinable by conductive methods of measurement. To this end different concentrations of the lithium salts (III)-(V) in sulfur dioxide are produced. Conductivities of the solutions are then determined using a two-electrode sensor immersed in the solution at constant room temperature. To this end the conductivity of the solution comprising the lithium salts (III)-(V) is measured in a range of 0-100 mS/cm.

Due to the high electrochemical stability of the lithium salts these are not involved in cyclic and calendrical aging processes in the battery cell.

The proposed lithium salts further exhibit an elevated thermal, chemical and electrochemical stability and a particularly pronounced hydrolysis-resistance. The thermal stability may be investigated for example by thermogravimetric analysis (TGA) and dynamic scanning calorimetry (DSC).

The elevated thermal, chemical and electrochemical stability of the proposed conducting salts increases the service life of lithium-ion batteries. The electrolyte compositions produced from the lithium salts are thus also more cost-effective in operation.

The recited properties of the lithium conducting salts further allow selection of a suitable recycling process. A recycling process based on water as solvent may be used with preference. The lithium conducting salts may thus be completely recovered from the end-of-life batteries.

The better recyclability of the electrolyte results in cost savings in the production process of the battery which may be offset against the production costs of the electrolyte salts.

In a further embodiment the electrolyte composition contains component (B) in a concentration of 0.01 to 15 mol/L, preferably 0.1 to 10 mol/L, particularly preferably 0.2 to 1.5 mol/L, based on the total volume of the electrolyte composition.

The electrolyte composition may further comprise at least one further additive in a proportion of 0-10% by weight, preferably 0.1-2% by weight, based on the total weight of the electrolyte composition.

In one embodiment the further additives comprise compounds selected from the group consisting of 2-vinylpyridine, 4-vinylpyridine, cyclic exomethylene carbonates, sulfones, cyclic and acyclic sulfonates, acyclic sulfites, cyclic and acyclic sulfinates, organic esters of inorganic acids, acyclic and cyclic alkanes, aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides and halogenated organic heterocycles.

The further additives may contribute to the stability of the electrolyte composition during operation in an electrochemical cell.

The further additives may further provide the electrolyte composition with at least one further lithium-containing conducting salt. In one embodiment the further lithium-containing conducting salt may contribute to adapting the conductivity of the electrolyte composition to the requirements of the respective cell or to increasing the corrosion-resistance of the cathodic metal carrier film.

Preferred lithium-containing conducting salts include lithium tetrafluoroborate (LiBF₄), lithium trifluoromethanesulfonate, lithium fluoride, lithium bromide, lithium sulfate, lithium oxalate, lithium (bisoxalato)borate, lithium difluoro(oxalato)borate, lithium tetrahaloaluminate, lithium hexafluorophosphate, lithium tris(perfluoropropyl)trifluorophosphate, lithium tris(perfluorobutyl)trifluorophosphate, lithium tris(perfluoropentyl)trifluorophosphate, lithium bis(trifluoromethanesulfonyl)imide (LiTFSI) and lithium bis(fluorosulfonyl)imide (LiFSI). Also included are possible isomers of the recited compounds.

The further additives may likewise also comprise further solvents. Further solvents may contribute to adjusting the solubility of the electrolyte composition for polar or nonpolar components in same.

The further solvents preferably include vinyl ethylene carbonate (VEC), ethyl methyl carbonate (EMC), vinylene carbonate (VC) and 4-fluoro-1,3-dioxolan-2-one (FEC).

In a further embodiment the further additives may also comprise at least one solid inorganic lithium ion conductor (solid-state electrolyte). Suitable examples of solid inorganic lithium-ion conductors include perovskites, garnets, sulfides, and amorphous compounds such as glasses, and combinations thereof.

In a particularly preferred embodiment the electrolyte composition comprises the following components:
(A) sulfur dioxide;
(B) at least one salt of above formula (I) in a concentration of 0.01-15 mol/L, preferably 0.1-10 mol/L, based on the total volume of the electrolyte composition, wherein the salt is preferably a lithium salt, particularly preferably selected from the group consisting of the compounds of formula (III), (IV) and (V) and combinations thereof;
(C) 0-10% by weight, preferably 0.1-2% by weight, of at least one additive, wherein the additive is preferably selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, lithium tris(perfluorethyl)trifluorophosphate, lithium tris(perfluoropropyl)trifluorophosphate, lithium tris(perfluorobutyl)trifluorophosphate, lithium tris(perfluoropentyl)trifluorophosphate, bis(trifluoromethanesulfonyl)imide (LiTFSI) and bis(fluorosulfonyl)imide (LiFSI), including isomers and combinations thereof, based on the total weight of the electrolyte composition.

The electrolyte composition according to the present disclosure exhibits an improved hydrolysis resistance in the recycling process and a higher conductivity with commercially easily obtainable bidentate ligands compared to an electrolyte composition comprising electrolyte salts of boron or aluminum.

The present disclosure further relates to an electrochemical cell comprising a cathode, an anode and the described electrolyte composition in contact with the cathode and the anode.

In an advantageous development of the present disclosure the electrochemical cell is a lithium-ion cell, wherein the electrolyte composition comprises the following components:
(A) sulfur dioxide;
(B) 0.5-2 mol/L of a salt of formula (I) based on the total volume of the electrolyte composition;
(C) 0.1-2% by weight of lithium hexafluorophosphate and 0.1-2% by weight of 4-fluoro-1,3-dioxolan-2-one (FEC), in each case based on the total weight of the electrolyte composition.

The proposed lithium-ion cells are cost-effective and can be safely operated at various operating voltages. The accompanying electrochemical properties may be determined through measurements on test cells.

The cyclic aging resistance of the test cells may be determined via the cycle number. The test cells are initially charged with a constant charging current strength up to a maximum allowable cell voltage. The upper cutoff voltage is kept constant until a charging current has fallen to a specified value or the maximum charging time has been reached. This is also known as I/U charging. This is followed by discharging of the test cells at a constant discharging current strength down to a specified cutoff voltage. The charging may be repeated depending on the desired cycle number. The upper cutoff voltage and the lower cutoff voltage as well as the particular charging or discharging current strengths must be selected by experiment. This also applies to the value to which the charging current has fallen.

The calendrical aging stability and the extent of self-discharging may be determined by storage of a fully charged battery cell, in particular at elevated temperature.

To this end the battery cell is charged up to the allowable upper voltage limit and kept at this voltage until the charging current has fallen to a previously specified threshold value.

The cell is then separated from the voltage supply and stored at elevated temperature, for example at 45° C., for a particular time in a temperature-controlled chamber, for example one month (variant 1).

The cell is then removed from the temperature-controlled chamber again and the residual capacity determined under defined conditions. This is done by selecting a discharging current which is for example one third of the nominal capacity and the cell is discharged down to the lower discharging limit at this current. This operation may be repeated as often as desired, for example until the detectable residual capacity has fallen to a previously specified value, for example 70% of the nominal capacity.

In a second variant of storage (variant 2) the storage is carried out in a temperature-controlled chamber with connected voltage supply, wherein the voltage corresponds to the upper voltage limit and this voltage is to be maintained.

Experiments according to both storage variants are performed.

These experiments are then used to determine the actual calendrical aging and the self-discharging of the battery cell. The calendrical aging corresponds to the capacity loss due to storage according to variant 2 and is calculated by subtracting the determined residual capacity 2 from the nominal capacity. The self-discharging rate is determined from the difference between the residual capacities 1 and 2 determined by storage according to variants 1 and 2 having regard to the nominal capacity of the battery cell.

The cathode of the lithium-ion cell preferably comprises a cathode active material.

Preferred cathode active materials for the electrochemical cell include lithium cobalt oxide (LCO), lithium nickel oxide (LNO), lithium nickel cobalt alumina (NCA), lithium nickel manganese cobalt oxide (NMC), lithium manganese oxide (LMO), lithium iron phosphate (LFP), lithium nickel manganese oxide (LMR), lithium nickel manganese oxide spinel (LNMO) and combinations thereof.

Lithium-nickel-manganese-cobalt compounds are also known under the abbreviation NMC, occasionally also under the technical abbreviation NCM. NMC-based cathode materials are used in particular in lithium-ion batteries for vehicles. NMC as a cathode material has an advantageous combination of desirable properties, for example a high specific capacity, a reduced cobalt content, a high high-current capacity and a high intrinsic safety, which is reflected, for example, in sufficient stability in the event of overcharging.

NMC may be described with the general formula unit Li_{α}NiₓMn_{y}Co_{z}O₂, where x+y+z=1, wherein a denotes the specification of the stoichiometric proportion of lithium and is typically between 0.95 and 1.05. Particular stoichiometries are specified in the literature as triplets, for example NMC 811, NMC 622, NMC 532 and NMC 111. The triplet in each case indicates the relative nickel:manganese:cobalt content. In other words, for example, NMC 811 is a cathode material with the general formula unit LiNi_{0.8}Mn_{0.1}Co_{0.1}O₂, in other words with α=1. In addition, it is also possible to use the so-called lithium- and manganese-rich NMCs with the general formula unit Li_{1+ε}(NiₓMn_{y}Co_{z})_{1-ε}O₂, wherein ε is especially between 0.1 and 0.6, preferably between 0.2 and 0.4. These lithium-rich layered oxides are also known as overlithiated (layered) oxides (OLO).

In addition to the cathode active material the cathode may comprise further components and additives, for example a foil carrier (rolled metal foil) or a metal-coated polymer film, an electrode binder and/or an electrical conductivity improver, for example conductivity carbon black. All customary compounds and materials known in the art may be used as further components and additives.

The anode of the lithium-ion cell preferably comprises an anode active material.

The anode active material may especially be selected from the group consisting of carbon-containing materials, soft carbon, hard carbon, natural graphite, synthetic graphite, silicon, silicon suboxide, silicon alloys, lithium, lithium alloys, aluminum alloys, indium, indium alloys, tin, tin alloys, cobalt alloys, niobium pentoxide, titanium dioxide, titanates, for example lithium titanates (Li₄Ti₅O₁₂ or Li₂Ti₃O₇), tin dioxide and mixtures thereof.

The anode active material is preferably selected from the group composed of synthetic graphite, natural graphite, graphene, mesocarbon, doped carbon, hard carbon, soft carbon, fullerene, silicon-carbon composite, silicon, surface-coated silicon, silicon suboxide, silicon alloys, lithium, aluminum alloys, indium alloys, tin alloys, cobalt alloys and mixtures thereof.

In addition to the anode active material, the anode may comprise further components and additives, for example a film carrier, an electrode binder and/or an electrical conductivity improver, for example conductive carbon black, conductive graphite, so-called “carbon nanotubes” (CNT), carbon fibers and/or graphene. Further components and additives that may be employed include all customary compounds and materials known in the art.

The present disclosure further relates to a salt comprising an anionic complex comprising three bidentate ligands, wherein the salt conforms to the following formula (I)

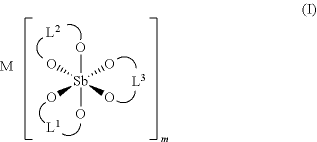

Therein M represents a metal cation selected from the group consisting of alkali metals, alkaline earth metal and metals of group 12 of the Periodic Table of the Elements. m represents an integer from 1 to 2. Sb represents the element antimony and represents the central ion of the anionic complex. L¹, L² and L³ each independently of one another represent a perfluorinated aliphatic or aromatic bridging radical. The bridging radical forms a five- to eight-membered ring with the central ion Sb and with two oxygen atoms bonded to the Sb and the bridging radical, wherein the ring forms a sequence of 2 to 5 carbon atoms optionally interrupted by an oxygen atom.

Having regard to the properties and advantages of the salt reference is made to the foregoing which also applies analogously to the salt as such.

It is preferable when the salt of formula (I) is a lithium triperfluoropicanolatoantimonate (LiSb(PFP)₃) of following formula (V):

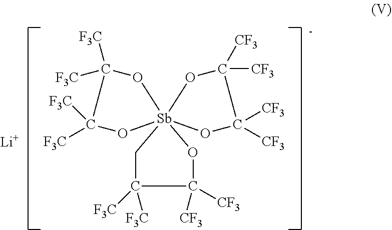

The salt of formula (V) is a lithium salt and features a high conductivity in sulfur dioxide.

The present disclosure further provides for the use of the aforementioned salts of formula (I) in an electrochemical cell.

It is preferable when the salt is employed as a lithium ion-conducting conducting salt in the electrochemical cell.

It is preferable when the lithium salt of formula (V) is employed as a conducting salt in an electrochemical cell. The lithium salt of formula (V) is cost effective, simple to produce and exhibits a higher conductivity compared to other conducting salts comprising anionic chelate complexes.

In a particularly advantageous embodiment it is provided that the electrochemical cell is based on sulfur dioxide as electrolyte.

### EXAMPLES

The present disclosure will now be elucidated with reference to examples which are, however, not to be considered as limiting.

### Synthesis of Lithium Triperfluoropicanolatoantimonate (LiSb(PFP)₃)

The synthesis of LiSb(PFP)₃ may be performed as described below.

Firstly, the compound bis-antimony pentaethoxide ([Sb(OEt)₅]₂) is synthesized as a precursor according to the procedure of Meerwein et al. (H. Meerwein, T. Bersin: Untersuchungen über Metallalkoholate und Orthosåureester: I. Über Alkoxosåuren und ihre Salze, Liebigs Ann. Chem. 476 1929 p. 113). Alternatively, the procedure of Arbuzov et al. (B. A. Arbuzov, Yu. M. Mareev, V. S. Vinogradova: Organic derivatives of antimony. 3. Alkoxy and chloroalkoxy derivatives of antimony. Izv. Akad. Nank SSSR, Ser. Khim. 901 1977 p. 824) may be used.

An alcoholic solution of bis-antimony pentaethoxide ([Sb(OEt)₅]₂) is then titrated with lithium ethoxide to give the intermediate LiSb(OEt)₆.

The purification of the intermediate is carried out by recrystallization in a solvent mixture of ethanol and decalin.

Subsequently, a mixture dissolved in toluene and consisting of lithium hexaethoxyantimonate (LiSb(OEt)₆) and perfluoropinacol is heated in an autoclave at 110° C. for 12 hours.

A cooling time of 12 hours is then maintained to cool the autoclave to room temperature. Lithium triperfluoropicanolatoantimonate (LiSb(PFP)₃) which crystallizes out in the solution during cooling is obtained as the reaction product.

The remaining solvent is removed by applying a reduced pressure of 10⁻² mbar and simultaneously heating to 40° C. overnight.

Finally, the dried LiSb(PFP)₃ may be dissolved in sulfur dioxide and filtered off to remove undissolved impurities.

1. A liquid electrolyte composition for an electrochemical cell, comprising:
(A) sulfur dioxide; and
(B) at least one salt of formula (I) 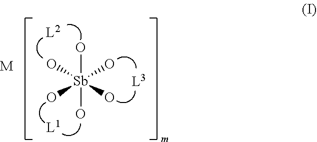
wherein
M is a metal cation selected from the group consisting of alkali metals, alkaline earth metals, and metals of group 12 of the Periodic Table of the Elements;
m is 1 or 2;
and
L¹, L² and L³ each independently represents a perfluorinated aliphatic or aromatic bridging radical, wherein the bridging radical forms a five- to eight-membered ring with the Sb and with two oxygen atoms bonded to the Sb and the bridging radical, and wherein the ring contains a chain of 2 to 5 carbon atoms optionally interrupted by an oxygen atom.

2. The electrolyte composition according to claim 1, wherein the metal cation M is lithium.

3. The electrolyte composition according to claim 1, wherein L¹, L², and/or L³ each independently comprises a linear, branched or cyclic saturated hydrocarbon chain.

4. The electrolyte composition according to claim 1, wherein the ring contains an uninterrupted chain of 2 to 5 carbon atoms.

5. The electrolyte composition according to claim 1, comprising at least one lithium salt of Sb(O₂C₃(CF₃)₆)₃ of formula (III) 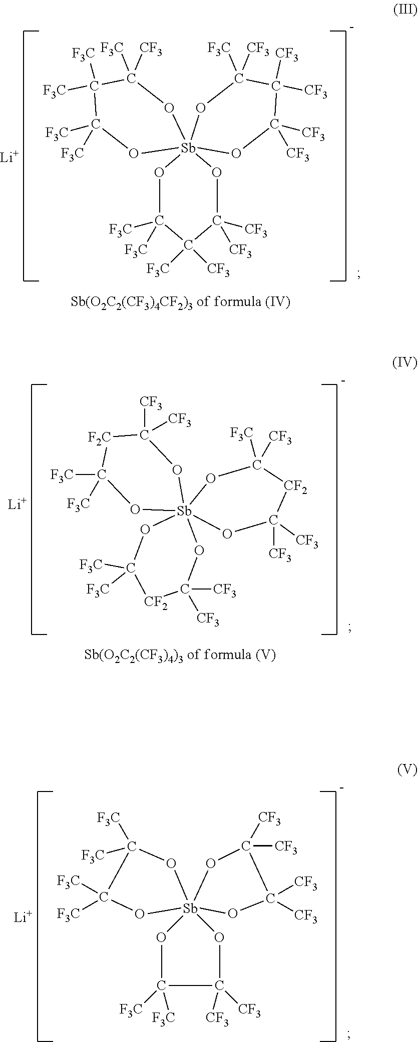
or combinations thereof.

6. The electrolyte composition according to claim 1, comprising the at least one salt in a concentration of 0.01 to 15 mol/L, based on the total volume of the electrolyte composition.

7. The electrolyte composition according to claim 1, comprising at least one further additive in a proportion of 0-10% by weight, based on the total weight of the electrolyte composition, wherein the further additive is selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, lithium tris(perfluorethyl)trifluorophosphate, lithium tris(perfluoropropyl)trifluorophosphate, lithium tris(perfluorobutyl)trifluorophosphate, lithium tris(perfluoropentyl)trifluorophosphate, bis(trifluoromethanesulfonyl)imide (LiTFSI), bis(fluorosulfonyl)imide (LiFSI), isomers thereof, and combinations thereof.

8. The liquid electrolyte composition according to claim 1, comprising:
(A) sulfur dioxide;
(B) at least one salt of formula (I) in a concentration of 0.01-15 mol/L, based on the total volume of the electrolyte composition; and
(C) 0-10% by weight, based on the total weight of the electrolyte composition, of at least one additive selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, lithium tris(perfluorethyl)trifluorophosphate, lithium tris(perfluoropropyl)trifluorophosphate, lithium tris(perfluorobutyl)trifluorophosphate, lithium tris(perfluoropentyl)trifluorophosphate, bis(trifluoromethanesulfonyl)imide (LiTFSI) bis(fluorosulfonyl)imide (LiFSI), isomers thereof, and combinations thereof.

9. An electrochemical cell comprising a cathode, an anode, and an electrolyte composition according to claim 1 in contact with the cathode and the anode.

10. The electrochemical cell according to claim 9, wherein the electrochemical cell is a lithium-ion cell, and wherein the electrolyte composition comprises:
(A) sulfur dioxide;
(B) 0.5-2 mol/L of a salt of formula (I) based on the total volume of the electrolyte composition; and
(C) 0.1-2% by weight of lithium hexafluorophosphate and 0.1-2% by weight of 4-fluoro-1,3-dioxolan-2-one (FEC), based on the total weight of the electrolyte composition.

11. A salt of formula (I) 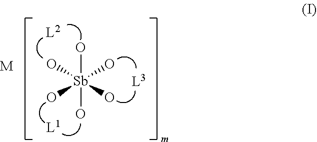
wherein
M is a metal cation selected from the group consisting of alkali metals, alkaline earth metals, and metals of group 12 of the Periodic Table of the Elements;
m is 1 or 2;
L¹, L² and L³ each independently represents a perfluorinated aliphatic or aromatic bridging radical, wherein the bridging radical forms a five- to eight-membered ring with the Sb and with two oxygen atoms bonded to the Sb and the bridging radical, and wherein the ring contains a chain of 2 to 5 carbon atoms optionally interrupted by an oxygen atom.

12. The salt according to claim 11, wherein the salt is lithium triperfluoropicanolatoantimonate (LiSb(PFP)₃) of formula (V):

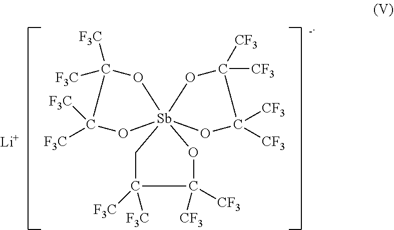

13. An electrochemical cell comprising the salt according to claim 11.

14. The electrochemical cell according to claim 13 wherein the salt is lithium ion-conducting.

15. The electrochemical cell according to claim 13, further comprising sulfur dioxide.

16. The electrolyte composition according to claim 1, wherein the at least one salt of formula (I) comprises a salt of formula (II) 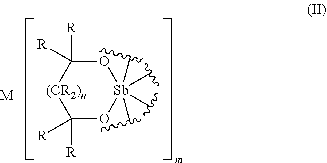
wherein each n is independently 0, 1, 2, or 3;
each R is independently C₁-C₁₀-alkyl, fluorine, or C₁-C₁₀-perfluoroalkyl;
M is a metal cation selected from the group consisting of alkali metals, alkaline earth metals, and metals of group 12 of the Periodic Table of the Elements; and
m is 1 or 2.

17. The electrolyte composition according to claim 16, wherein each R is independently selected from the group consisting of trifluoromethyl, perfluoroethyl, perfluoropropyl, perfluoroisopropyl, perfluoro-n-butyl, perfluoro-sec-butyl, perfluoroisobutyl, and perfluoro-tert-butyl.

18. The electrolyte composition according to claim 1, comprising the at least one salt in a concentration of 0.1 to 10 mol/L.

19. The salt of formula (I) according to claim 11, comprising a salt of formula (II) 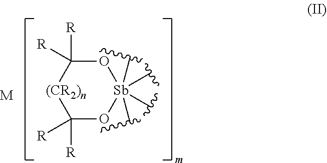
wherein each n is independently 0, 1, 2, or 3;
each R is independently C₁-C₁₀-alkyl, fluorine, or C₁-C₁₀-perfluoroalkyl;
M is a metal cation selected from the group consisting of alkali metals, alkaline earth metals, and metals of group 12 of the Periodic Table of the Elements; and
m is 1 or 2.

20. The electrolyte composition of claim 19, wherein each R is independently selected from the group consisting of trifluoromethyl, perfluoroethyl, perfluoropropyl, perfluoroisopropyl, perfluoro-n-butyl, perfluoro-sec-butyl, perfluoroisobutyl, and perfluoro-tert-butyl.
